(19) United States
(12) Patent Application Publication
(10) Pub. No.: US 2024/0346932 A1
(43) Pub. Date: Oct. 17, 2024

(54) METHOD AND DEVICE FOR AVOIDING ACCIDENTS AT AN INTERSECTION SYSTEM

(71) Applicant: Robert Bosch GmbH, Stuttgart (DE)

(72) Inventor: Holger Mindt, Steinheim A.D. Murr (DE)

(21) Appl. No.: 18/613,039

(22) Filed: Mar. 21, 2024

(30) Foreign Application Priority Data
Apr. 11, 2023 (DE) 10 2023 203 279.1

(51) Int. Cl. G08G 1/16; B60W 30/18; G08G 1/01

(52) U.S. Cl. CPC G08G 1/166; B60W 30/18159; G08G 1/0125; B60W 2554/4041; B60W 2554/4042; B60W 2555/60; B60W 2556/45; B60W 2710/18; B60W 2720/10

(57) ABSTRACT

A method for avoiding accidents at an intersection system, in particular in the context of automated driving. The method includes: receiving a transmitted traffic light signal, wherein the traffic light signal represents current traffic light phase of a traffic light of the intersection system and an associated lane, i.e., a lane assigned to the traffic light; detecting a traffic flow which crosses the traffic flow controlled by the traffic light signal, and ascertaining characterizing data of the crossing traffic flow; generating an object list from the characterizing data; evaluating the object list as to whether anomalies of one or more objects of the object list exist with respect to the transmitted traffic light signal; and outputting a warning if an anomaly is determined.

### CROSS REFERENCE

The present application claims the benefit under 35 U.S.C. § 119 of German Patent Application No. DE 10 2023 203 279.1 filed on Apr. 11, 2023, which is expressly incorporated herein by reference in its entirety.

### FIELD

The present invention relates to a method for avoiding accidents at an intersection system, in particular in the context of automated driving. The present invention also relates to a device for avoiding accidents at an intersection system, in particular within the framework of driving assistance of networked motor vehicles guided in a partially automated manner. The present invention also relates to a computer program.

### BACKGROUND INFORMATION

As in other fields of technology, networking is playing an increasingly important role in vehicle applications. More and more vehicles have the possibility of connecting, within a cloud, to other road users, to infrastructure components (e.g., so-called roadside units) or to backend services.

A networked, at least partially automated motor vehicle can, for example, be assisted at particularly challenging locations, such as tunnel entrances, construction sites or intersection, by information from outside the vehicle (for example, generated by stationary environmental sensors at the challenging location) or can be guided by means of this information. This information can in particular be used to assist safety-critical functions or make them possible in the first place. Examples of such information are critical route sections (“construction site ahead,” tunnel entrances . . . ), a list of the other road users (vehicles, pedestrians, . . . ) in a specific area, freeway ramps, traffic lights, intersections, and obstacles in an area. Vehicles driving in a highly automated manner often have difficulties reliably recognizing traffic lights in urban areas independently. In order to remedy this, it is known that traffic light systems not only emit their signals by light signals but also transmit them by radio transmission to the cars or into a further, in particular stationary, processing unit (e.g., ICU, RSU, cloud).

Situations can nevertheless occur in which a light signal system indicates, and also correctly emits, a right of way, but this right of way is disregarded by other road users or is overruled by emergency vehicles with special rights.

U.S. Patent Application No. US 2021/0162995 A1 describes a method for avoiding accidents at an intersection system in the context of automated driving. In this case, a traffic light signal and a vehicle environment are acquired and combined by the HAD vehicle.

PCT Patent Application No. WO 2018/195150 A1 describes a method for recognizing a signal status by means of a highly automated vehicle. In this case, a signaling device is identified in an image recorded by the vehicle and the signal status is ascertained by evaluating sensor data relating to the velocity state of one or more adjacent vehicles.

### SUMMARY

It is an object of the present invention to provide a reliable method for avoiding accidents at an intersection system, in particular in the context of automated driving.

It is a further object of the present invention to provide a device for avoiding accidents at an intersection system, in particular within the framework of driving assistance of networked motor vehicles guided in a partially automated manner, which has a high reliability.

According to a first aspect of the present invention, a method for avoiding accidents at an intersection system is provided, in particular in the context of automated driving. According to an example embodiment of the present invention, the method comprises at least the steps of:
receiving a transmitted traffic light signal, wherein the traffic light signal represents current traffic light phase of a traffic light of the intersection system and an associated lane, i.e., a lane assigned to the traffic light;
detecting a traffic flow which crosses the traffic flow controlled by the traffic light signal, and ascertaining characterizing data of the crossing traffic flow;
generating an object list from the characterizing data;
evaluating the object list as to whether anomalies of one or more objects of the object list exist with respect to the transmitted traffic light signal;
and outputting a warning if an anomaly is determined.

Examples of such anomalies include red light runners, i.e., vehicles of the crossing traffic flow that intentionally or unintentionally drive through a traffic light showing red, or rescue vehicles or emergency vehicles that drive through a traffic light showing red for the crossing traffic, and can thus come into conflict with an at least partially automated motor vehicle which passes a traffic light showing green at this time.

The present invention is accordingly based in particular on the idea that object lists of all objects in the area of the traffic light (for example, approximately 100 m before the traffic light system) are evaluated for an intersection equipped with infrastructure sensors for assisting automated motor vehicles. These object lists can be used to assess the crossing traffic. An evaluation unit (e.g., an ICU, RSU, cloud . . . ) is required, which compares the transmitted traffic light signals to the detected crossing object lists and reports anomalies, to which an automated motor vehicle may respond. Accidents or dangerous situations in the area of the intersection system are thus efficiently avoided.

In this case, the traffic light signal is transmitted in particular in addition to the actual light signal of the traffic light. The traffic light signal can, for example, be transmitted via a wireless data connection, for example by means of V2X communication. The traffic light signal can be transmitted to an infrastructure system and/or to a networked road user. The traffic light signal preferably comprises data representing a current traffic light phase of a traffic light of the intersection system. In addition, the traffic light signal may comprise further information, for example a time stamp, and/or a duration until a change of the traffic light phase, and/or further information.

For this purpose, according to an example embodiment of the present invention, the object list preferably comprises position data and/or velocity data and/or acceleration data of objects of the crossing traffic flow. In this way, anomalies can be recognized particularly efficiently.

The objects may be, for example, motor vehicles or pedestrians or other road users, whose movement is controlled, for example, by a second traffic light system or a second traffic light of the traffic light system.

According to an example embodiment of the present invention, the characterizing data of the crossing traffic flow are preferably determined by means of a stationary sensor system of an infrastructure system. For this purpose, the sensor system can, for example, have environmental sensors arranged in a stationary manner in the area of the intersection system, which environmental sensors are designed, for example, as video cameras and/or as lidar sensors and/or as radar sensors. Alternatively or additionally, pressure sensors, for example in the road surface and/or light barriers, can also be comprised by the sensor system. The measurement data detected by the environmental sensors and/or other sensors can be evaluated within the respective sensor and/or by a central computing unit (e.g., an RSU or a cloud), and characterizing data of the crossing traffic flow can be ascertained therefrom. By using such a stationary sensor system, a particularly current and accurate ascertainment of the characterizing data of the crossing traffic flow can advantageously be ensured.

Alternatively or additionally, according to an example embodiment of the present invention, environmental sensors of vehicles in the environment of the intersection system can be used to detect characterizing data of the crossing traffic flow. The data can, for example, be transmitted to the central computing unit by means of V2X communication and processed there in order to create an object list.

An anomaly can in particular be recognized if the evaluation of the object list results in a collective evasive movement of the objects of the crossing traffic flow. In particular, sideways movements of vehicles of the crossing traffic flow can thus be detected, which are indicative of an obstacle or an approaching fast object.

An anomaly can in particular be recognized if one or more objects of the crossing traffic flow have a position or velocity that is not permitted with respect to the traffic light signal. In this way, objects that ignore a red signal of a traffic light that controls the crossing traffic flow can in particular be recognized.

An anomaly can in particular be recognized if it is determined on the basis of the traffic light signal that the objects of the crossing traffic flow should have a decreasing velocity and/or a velocity of zero, and at least one other object in the object list has an increasing or a constant, in particular increased, velocity. Such a constellation of object properties can indicate that a vehicle is in the process of driving through a red signal and thereby causing an accident hazard.

In particular, an approaching emergency vehicle in a lane of the crossing traffic flow is recognized as an anomaly. An emergency vehicle will move independently of the traffic light phase at a high, increasing or constant velocity. Furthermore, vehicles that are already waiting in the crossing lane before the traffic light will perform characteristic evasive movements (rescue lane). This characteristic behavior can advantageously be recognized when the object list is evaluated. An emitted warning can contain the information that an emergency vehicle is traveling in the crossing lane. In this way, emergency vehicles with special rights of way can advantageously be recognized efficiently, and at least partially automated motor vehicles can be informed and can derive measures therefrom.

A warning output according to the present invention preferably comprises a V2X message, which is transmitted to at least one networked motor vehicle which is guided in an at least partially automated manner and moves in the area of the traffic light. In particular, the V2X message comprises an instruction to transition the motor vehicle into a safe state, i.e., to stop it, for example.

The warning can in particular trigger a measure of the networked motor vehicle guided in a partially automated manner, in particular a reduction of the velocity and/or a prefilling of a brake system. An accident hazard can thus be efficiently reduced by preventive measures.

According to a second aspect of the present invention, a device is proposed, which is configured to carry out all steps of the method according to the first aspect. For this purpose, the device in particular comprises a communication unit, which is designed to transmit and/or receive a traffic light signal, wherein the traffic light signal represents a current traffic light phase of a traffic light of the intersection system. The device furthermore comprises in particular a detection system, which is designed to detect a traffic flow which crosses the traffic flow controlled by the traffic light signal, and for ascertaining characterizing data of the crossing traffic flow. The device furthermore comprises in particular an evaluation unit, which is designed to evaluate the characterizing data and to generate an object list, wherein the object list is evaluated as to whether anomalies of one or more objects of the object list with respect to the traffic light signal exist.

Furthermore, the device in particular comprises an output unit, which is designed to output a warning, wherein the warning is output if an anomaly is determined.

According to a third aspect of the present invention, an infrastructure system for driving assistance of networked motor vehicles guided in an at least partially automated is proposed, which infrastructure system is configured to carry out all steps of the method according to the first aspect and/or which comprises a device according to the second aspect.

According to a fourth aspect of the present invention, a computer program comprising commands which, when the computer program is executed by a computer, cause the computer to perform a method according to the first aspect is proposed.

According to a fifth aspect of the present invention, a machine-readable storage medium is proposed, on which the computer program according to the fourth aspect is stored.

The wording “networked motor vehicle” covers a motor vehicle which has a suitable communication device with which the networked motor vehicle can exchange data with other road users, in particular with an infrastructure system. For this purpose, a wireless data connection is established, via which the networked motor vehicle can transmit and/or receive data. It can preferably be a radio connection, for example a mobile radio connection or a direct wireless connection. Such communication between a motor vehicle and another road user is also referred to as V2X or C2X communication.

The wording “at least semi-automated” covers one or more of the following cases: assisted driving, semi-automated driving, highly automated driving, and fully automated driving of a motor vehicle.

Assisted guidance means that a driver of the motor vehicle continuously carries out either the lateral or longitudinal guidance of the motor vehicle. The respective other driving task (i.e., a control of the longitudinal or lateral guidance of the motor vehicle) is carried out automatically. This means that, with assisted guidance of the motor vehicle, either the lateral or the longitudinal guidance is controlled automatically.

Partially automated guidance means that in a specific situation (for example: driving on a freeway, driving within a parking lot, overtaking an object, driving within a lane defined by lane markings) and/or for a certain period of time a longitudinal and a lateral guidance of the motor vehicle are automatically controlled. A driver of the vehicle does not have to manually control the longitudinal and lateral guidance of the motor vehicle. However, the driver must continuously monitor the automatic control of the longitudinal and lateral guidance in order to be able to intervene manually if necessary. The driver must be prepared to fully take over the motor vehicle at any time.

Highly automated guidance means, for example, that for a certain period of time in a specific situation (for example: driving on a freeway, driving within a parking lot, overtaking an object, driving within a lane defined by lane markings), a longitudinal and a lateral guidance of the motor vehicle are automatically controlled. A driver of the motor vehicle does not have to manually control the longitudinal and lateral control of the motor vehicle himself. The driver does not have to continuously monitor the automatic control of the longitudinal and lateral guidance in order to be able to intervene manually if necessary. If required, a prompt to take over the control of the longitudinal and lateral guidance is automatically output to the driver, in particular output with a sufficient time reserve. The driver therefore potentially has to be able to take over the control of the longitudinal and lateral guidance. Limitations of the automatic control of the lateral and longitudinal guidance are automatically detected. In highly automated guidance, it is not possible to bring about a state of minimal risk automatically in every starting situation.

Fully automated guidance means, for example, that in a specific situation (for example: driving on a freeway, driving within a parking lot, overtaking an object, driving within a lane defined by lane markings), a longitudinal and a lateral guidance of the motor vehicle are automatically controlled. A driver of the vehicle does not have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is terminated, the driver is automatically prompted to take over the driving task (controlling the lateral and longitudinal guidance of the motor vehicle), in particular with a sufficient time reserve. If the driver does not take over the driving task, a return to a state of minimal risk is automatically made. Limitations of the automatic control of the lateral and longitudinal guidance are automatically detected. In all situations, it is possible to return to a system state of minimal risk automatically.

Driverless control or driving, for example, means that, independently of a specific application case (for example: driving on a freeway, driving within a parking lot, overtaking an object, driving within a lane defined by lane markings), longitudinal and lateral control of the motor vehicle are controlled automatically. A driver of the motor vehicle does not have to manually control the longitudinal and lateral control of the motor vehicle himself. The driver does not have to monitor the automatic control of the longitudinal and lateral guidance in order to be able to intervene manually if necessary. The longitudinal and lateral control of the vehicle is thus controlled automatically, for example, for all road types, speed ranges and environmental conditions. The entire driving task of the driver is thus taken over automatically. The driver is therefore no longer required. The motor vehicle can thus drive even without a driver from any starting position to any desired destination position. Potential problems are solved automatically, i.e., without the help of the driver.

Remote control of the motor vehicle, for example, means that longitudinal and lateral control of the motor vehicle is controlled remotely. This means, for example, that remote control signals are sent to the motor vehicle for remotely controlling the lateral and longitudinal control. Remote control is carried out, for example, by means of a remote control device.

### BRIEF DESCRIPTION OF THE DRAWINGS

Example embodiments of the present invention are described in detail with reference to the figures.

FIG. 1 shows a flowchart of a method according to a first exemplary embodiment of the present invention.

FIG. 2 shows a device according to a second exemplary embodiment of the present invention.

FIG. 3 shows a storage medium with a computer program according to a third exemplary embodiment of the present invention.

FIGS. 4A to 4C schematically show a situation at a traffic light system and the reception of a traffic light signal by an automated motor vehicle at three different times during the performance of a method for avoiding accidents according to an embodiment of the present invention.

FIG. 5 schematically shows a situation at a traffic light system during the performance of a method for avoiding accidents according to an embodiment of the present invention according to an alternative embodiment of the present invention.

### DETAILED DESCRIPTION EXAMPLE EMBODIMENTS

In the following description of the exemplary embodiments of the present invention, identical elements are denoted by the same reference signs, and repeated description of these elements may be omitted if necessary. The figures show the subject matter of the present invention only schematically.

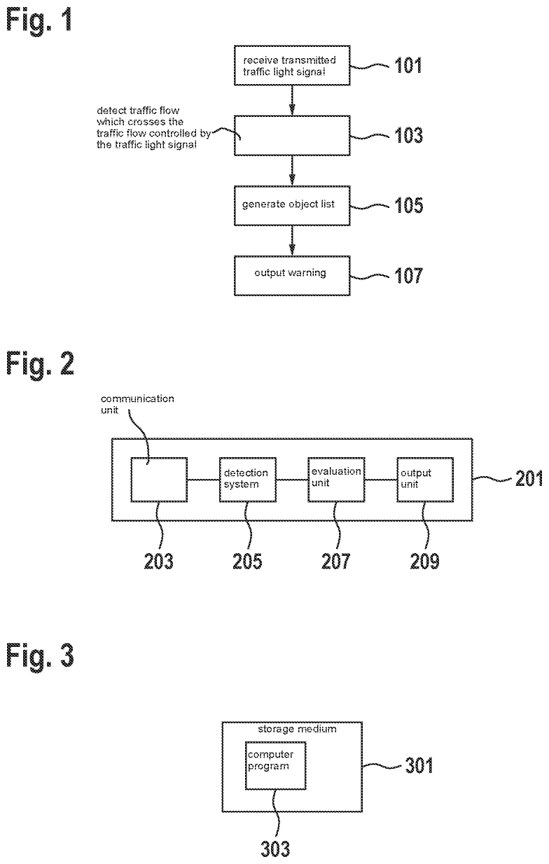

FIG. 1 shows a sequence of a method for carrying out a plausibility check of a transmitted traffic light signal at an intersection system according to a possible embodiment of the present invention. In a first step 101, a transmitted traffic light signal is received, wherein the traffic light signal represents a current traffic light phase of a traffic light of the intersection system and an associated lane. The traffic light signal can, for example, be transmitted by radio and comprises the information as to whether the current traffic light phase is “red,” “red-yellow,” “yellow,” or “green.” The traffic light signal is preferably transmitted at regular time intervals. In a subsequent second step 103, a traffic flow which crosses the traffic flow controlled by the traffic light signal is detected, and characterizing data of the crossing traffic flow are ascertained. For this purpose, measurement data of a stationary environmental sensor in the area of the intersection system are detected and evaluated, for example. In a subsequent step 105, an object list is generated from the characterizing data and is evaluated as to whether anomalies of one or more objects of the object list exist with respect to the transmitted traffic light signal. In step 107, a warning is output in the event that an anomaly is determined in step 105.

FIG. 2 shows a device 201, which is configured to carry out all steps of a method according to the present invention for carrying out a plausibility check of a transmitted traffic light signal at an intersection system. The device 201 comprises a communication unit 203, which is designed to transmit and/or receive a traffic light signal, wherein the traffic light signal represents a current traffic light phase and associated lane of a traffic light of the intersection system. The device 201 also comprises in particular a detection system 205, which is designed to detect a traffic flow which crosses the traffic flow controlled by the traffic light signal, and for ascertaining characterizing data of the crossing traffic flow. For this purpose, the detection system 205 can, for example, receive measurement data from environmental sensors. The device furthermore comprises an evaluation unit 207, which is configured to evaluate the characterizing data and to generate an object list, wherein the object list is evaluated as to whether anomalies of one or more objects of the object list with respect to the traffic light signal exist. The device 201 also comprises an output unit 209, designed to output a warning if an anomaly is determined.

FIG. 3 shows a storage medium 301 on which a computer program 303 is stored. The computer program comprises commands which, when the computer program 303 is executed by a computer, cause the computer to perform a method for carrying out a plausibility check of a transmitted traffic light signal at an intersection system according to a possible embodiment of the present invention.

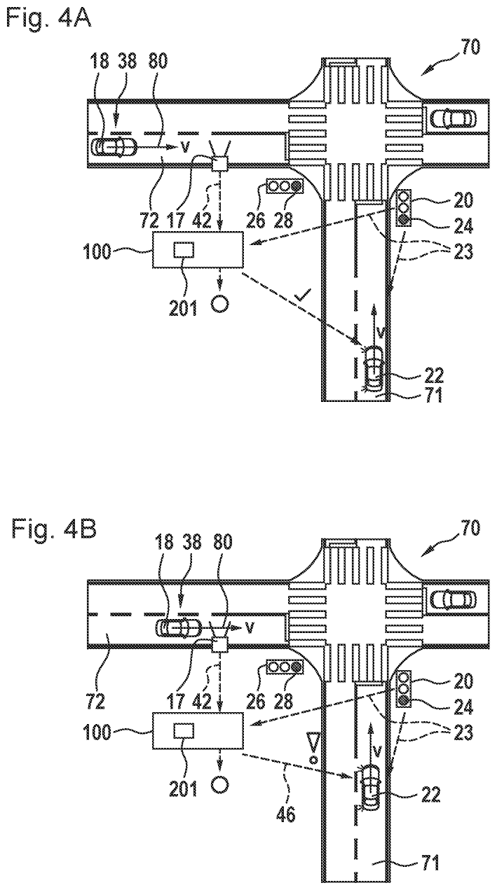

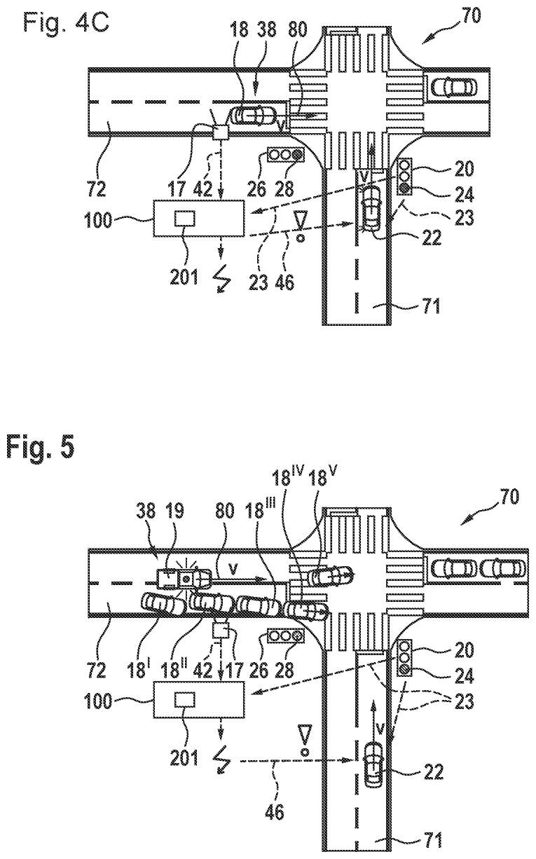

FIGS. 4A-4C schematically show how the detection of a traffic flow which crosses the traffic flow controlled by the traffic light signal and the ascertainment of characterizing data of the crossing traffic flow and an object list generated therefrom can be used to deduce anomalies and thus an accident hazard.

FIG. 4A shows an intersection system 70 at a first time t1. A highly automated motor vehicle 22 approaches the intersection in a lane 71. The traffic flow of the lane 71 is controlled by a traffic light 20. The traffic light 20 currently shows the traffic light phase 24 “green.” The traffic light 20 transmits a traffic light signal 23, which represents the current traffic light phase 24 of the traffic light 20, to the motor vehicle 22 and to an infrastructure system 100 (for example, an RSU) with a device 201 which is configured to perform a method for carrying out accident avoidance. For this purpose, the traffic flow 38 in the lane 72 is detected by means of a detection system, which traffic flow crosses the traffic flow controlled by the traffic light 20 or the traffic light signal 23, wherein the detection system in this example comprises an environmental sensor 17, which is designed as a stationary camera. Alternatively, a plurality of environmental sensors may also be present. Alternatively or additionally, lidar sensors, radar sensors, or similar sensors can be used as environmental sensors. Ultrasonic sensors, stereo video cameras, or a 6G detection are also possible. Characteristic data of the crossing traffic flow 38 are ascertained. For this purpose, an object 18 in the lane 72 in the area of the intersection (e.g., 50 meters to 100 meters before the intersection) is, for example, detected and its position, velocity 80 and/or acceleration are measured. If a plurality of objects 18 has been detected, these objects can be combined to form an object list. The object list, as data 42 characterizing the crossing traffic flow, can now be evaluated by the device 201 as to whether it comprises an anomaly from which an accident hazard could arise. At the time shown, the object 18, in this example a manually guided motor vehicle, approaches the intersection at a particular velocity 80. The traffic light 26 currently shows the traffic light phase 28 “red.” There is still the possibility that the object 18 brakes in time in order to come to a standstill before the traffic light 26. Thus, no anomaly is recognized yet.

In FIG. 4B, the same intersection system 70 is shown at a slightly later, second time t2. Characterizing data of the crossing traffic flow 38 are again ascertained, and an object list is generated therefrom. The evaluation of the object list has the result that the object 18 moves toward the traffic light 26 with a velocity 80 which is not reduced in comparison to the first time t1, wherein the traffic light 26 continues to indicate the traffic light phase 28 “red.” The device 201 now recognizes this behavior as an anomaly since a hazard to the traffic of the lane 71 could occur. The infrastructure system 100 and/or the device 201 can now output a warning 46 at least to the highly automated motor vehicle 22 so that the highly automated motor vehicle 22 throttles its velocity and/or can put a brake system on standby even though the traffic light 20 of indicates a green signal 24 for the lane 71 and also transmits it 23.

In FIG. 4C, the same intersection system 70 is shown at another later, third time t3. Characterizing data of the crossing traffic flow 38 are again ascertained, and an object list is generated therefrom. The evaluation of the object list has the result that the object 18 continues to move toward the traffic light 26 with a velocity 80 which is not reduced in comparison to the first time t1, wherein the traffic light 26 continues to indicate the traffic light phase 28 “red.” On the basis of the position of the object 18 and the velocity 80, the evaluation of the object list has the result that the object 18 will drive through the intersection despite the red phase of the traffic light 26. This is evaluated as an anomaly and the infrastructure system 100 and/or the device 201 can now output a warning 46 at least to the highly automated motor vehicle 22, wherein the warning can comprise an accident avoidance instruction or recommendation that the highly automated motor vehicle 22 stops and/or swerves.

FIG. 5 shows an intersection system 70. A highly automated motor vehicle 22 approaches the intersection in a lane 71. The traffic flow of the lane 71 is controlled by a traffic light 20. The traffic light 20 currently shows the traffic light phase 24 “green.” The traffic light 20 transmits a traffic light signal 23, which represents the current traffic light phase 24 of the traffic light 20, to the motor vehicle 22 and to an infrastructure system 100 (for example, an RSU) with a device 201 which is configured to perform a method for carrying out accident avoidance. For this purpose, the traffic flow 38 in the lane 72 is detected by means of a detection system, which traffic flow crosses the traffic flow controlled by the traffic light 20 or the traffic light signal 23, wherein the detection system in this example comprises an environmental sensor 17, which is designed as a stationary camera. Alternatively, a plurality of environmental sensors may also be present. Characteristic data of the crossing traffic flow 38 are ascertained. For this purpose, a plurality of objects 18-18^{V} and 19 in the lane 72 in the area of the intersection (e.g., 50 meters to 100 meters before the intersection) is, for example, detected and their positions, velocities and/or acceleration are measured. The objects 18′-18^{V} and 19 are combined to form an object list. The object list, as data 42 characterizing the crossing traffic flow 38, can now be evaluated by the device 201 as to whether it comprises an anomaly from which an accident hazard could arise. At the time shown, the object 19, which is designed as an emergency vehicle, approaches the intersection at a high velocity 80. The objects 18′-18^{V} are manually or at least partially automated motor vehicles. In order to make room for the emergency vehicle, the objects 18′-18^{V} perform evasive movements. When the object list is evaluated, this behavior of the objects 18′-18^{V} and 19 is recognized and classified as an anomaly. The infrastructure system 100 and/or the device 201 can now output a warning 46 at least to the highly automated motor vehicle 22 so that the highly automated motor vehicle 22 can, for example, stop until the emergency vehicle has passed the intersection. An accident can thus be avoided.

What is claimed is:

1. The method for avoiding accidents at an intersection system in the context of automated driving, the method comprising the following steps:
receiving a transmitted traffic light signal, wherein the traffic light signal represents a current traffic light phase of a traffic light of the intersection system and an associated lane;
detecting a traffic flow which crosses a traffic flow controlled by the traffic light signal, and ascertaining characterizing data of the crossing traffic flow;
generating an object list from the characterizing data;
evaluating the object list as to whether anomalies of one or more objects of the object list exist with respect to the transmitted traffic light signal; and
outputting a warning when an anomaly is determined.

2. The method according to claim 1, wherein the object list includes position data and/or velocity data and/or acceleration data of objects of the crossing traffic flow.

3. The method according to claim 1, wherein the characterizing data of the crossing traffic flow are determined using a stationary sensor system of an infrastructure system.

4. The method according to claim 1, wherein an anomaly is recognized when the evaluation of the object list results in a collective evasive movement of objects of the crossing traffic flow.

5. The method according to claim 1, wherein an anomaly is recognized when one or more objects of the crossing traffic flow have a position or velocity that is not permitted with respect to the traffic light signal.

6. The method according to claim 2, wherein an anomaly is recognized when it is determined based on the traffic light signal that the objects of the crossing traffic flow should have a decreasing velocity and/or a velocity of zero, and at least one object in the object list has an increasing or a constant increased velocity.

7. The method according to claim 1, wherein an approaching emergency vehicle in a lane of the crossing traffic flow is recognized as an anomaly.

8. The method according to claim 1, wherein the warning includes a V2X message, which is transmitted to at least one networked motor vehicle which is guided in an at least partially automated manner and moves in an area of the traffic light, and wherein the V2X message includes an instruction to transition the motor vehicle into a safe state.

9. The method according to claim 1, wherein the warning triggers a measure of the networked motor vehicle guided in a partially automated manner, including a reduction of a velocity and/or a prefilling of a brake system.

10. A device for avoiding accidents at an intersection system in the context of automated driving, comprising:
a communication unit configuerd to transmit and/or receive a traffic light signal, wherein the traffic light signal represents a current traffic light phase of a traffic light of the intersection system and an associated lane;
a detection system configured to detect a traffic flow which crosses a traffic flow controlled by the traffic light signal, and for ascertaining characterizing data of crossing traffic flow;
an evaluation unit configured to evaluate the characterizing data and to generate an object list, wherein the object list is evaluated as to whether anomalies of one or more objects of the object list exist with respect to the traffic light signal exist; and
an output unit configured to output a warning when an anomaly is determined.

11. An infrastructure system for driving assistance of networked motor vehicles guided in an at least partially automated manner, the infrastructure system comprising:
a device for avoiding accidents at the intersection system, the device including:
a communication unit configuerd to transmit and/or receive a traffic light signal, wherein the traffic light signal represents a current traffic light phase of a traffic light of the intersection system and an associated lane,
a detection system configured to detect a traffic flow which crosses a traffic flow controlled by the traffic light signal, and for ascertaining characterizing data of crossing traffic flow,
an evaluation unit configured to evaluate the characterizing data and to generate an object list, wherein the object list is evaluated as to whether anomalies of one or more objects of the object list exist with respect to the traffic light signal exist, and
an output unit configured to output a warning when an anomaly is determined.

12. A non-transitory machine-readable storage medium on which is stored a computer program for avoiding accidents at an intersection system in the context of automated driving, the computer program, when executed by a computer, causing he computer to perform the following steps:
receiving a transmitted traffic light signal, wherein the traffic light signal represents a current traffic light phase of a traffic light of the intersection system and an associated lane;
detecting a traffic flow which crosses a traffic flow controlled by the traffic light signal, and ascertaining characterizing data of the crossing traffic flow;
generating an object list from the characterizing data;
evaluating the object list as to whether anomalies of one or more objects of the object list exist with respect to the transmitted traffic light signal; and
outputting a warning when an anomaly is determined.
